(19) United States
(12) Patent Application Publication
(10) Pub. No.: US 2022/0232038 A1
(43) Pub. Date: Jul. 21, 2022

(54) Web Conference Security

(71) Applicant: McAfee, LLC, San Jose, CA (US)

(72) Inventors: Dattatraya Kulkarni, Bangalore (IN); Srikanth Nalluri, Bangalore (IN); Raghavendra Satyanarayana Hebbalalu, Karnataka (IN); Joseph Gullo, Pleasanton, CA (US)

(73) Assignee: McAfee, LLC, San Jose, CA (US)

(21) Appl. No.: 17/401,429

(22) Filed: Aug. 13, 2021

Related U.S. Application Data
(60) Provisional application No. 63/139,909, filed on Jan. 21, 2021.

(51) Int. Cl. H04L 29/06; G06F 16/11

(52) U.S. Cl. CPC H04L 63/20; H04L 63/10; G06F 9/44526; H04L 65/1089; H04L 65/4015; G06F 16/116

(57) ABSTRACT

There is disclosed, by way of example, a computing apparatus, including a hardware platform having a processor and a memory; and instructions encoded within the memory to instruct the processor to provide access to a web conference; determine that an object has been shared via the web conference; determine a reputation for the object; and according to the reputation, modify a conference experience for at least one participant of the web conference

### CROSS REFERENCE TO RELATED APPLICATIONS

This application claims the benefit of and priority from U.S. Provisional Application Ser. No. 63/139,909 titled “Videoconference Security” filed on Jan. 21, 2021, thereby incorporated by reference in its entirety.

### FIELD OF THE SPECIFICATION

This application relates in general to computer security, and more particularly though not exclusively to a system and method for providing web conference security.

### BACKGROUND

The COVID-19 pandemic has drastically increased the use of video web conferences.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a web conference ecosystem.

FIG. 2 is a block diagram of selected elements of an endpoint device.

FIG. 3 is a block diagram of selected elements of a web conference.

FIG. 4 is a flow chart of a web conference security method.

FIG. 5 is a flow chart of a web conference security method.

FIG. 6 is a flow chart of a web conference security method.

FIG. 7 is a flow chart of a web conference security method.

FIG. 8 is a block diagram of selected elements of a hardware platform.

FIG. 9 is a block diagram of selected elements of a system-on-a-chip (SoC).

FIG. 10 is a block diagram of selected elements of a trusted execution environment (TEE).

FIG. 11 is a block diagram of selected elements of a network function virtualization (NFV) infrastructure.

FIG. 12 is a block diagram of selected elements of a containerization infrastructure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing apparatus. The computing apparatus also includes a hardware platform may include a processor and a memory. The apparatus also includes instructions encoded within the memory to instruct the processor to: provide access to a web conference; determine that an object has been shared via the web conference; determine a reputation for the object; and according to the reputation, modify a conference experience for at least one participant of the web conference. Other embodiments of this aspect include corresponding computer systems, apparatus, and computer programs recorded on one or more computer storage devices, each configured to perform the actions of the methods.

Implementations may include one or more of the following features. The computing apparatus where modifying the conference experience may include notifying the at least one participant of the reputation. The object is a uniform resource locator (URL). Determining that the object has been shared may include determining that the object was shared via a chat or instant message feature of the web conference. The instructions are further to provide optical character recognition (OCR) on the screen share feature. The instructions are further to determine that a remote device participating in the web conference has begun screen recording, and where modifying the conference experience may include notifying the at least one participant of the screen recording. Determining that the remote device has begun screen recording may include receiving a message from a conference client of the remote device. The instructions are further to determine that screen recording has begun on the computing apparatus, and where modifying the conference experience may include notifying the at least one participant. The instructions provide a server for the web conference. The instructions provide a client for the web conference. The instructions provide a browser plugin. The browser plugin is to receive via a cloud service a reputation for another browser plugin, where the instructions are to contextually disable the other browser plugin according to the reputation. Receiving the reputation for the other browser plugin may include determining that the other browser plugin has document object model (DOM) or screen scraping capability. Determining that screen recording has begun may include observing DirectX activity. Determining that screen recording has begun may include statically observing an application with screen recording capability. Determining that screen recording has begun may include dynamically observing application behavior Determining that screen recording has begun may include hybrid static and dynamic analysis. Determining that the object has been shared may include determining that the object was shared via a screen share feature of the web conference. The object is a file. Determining the reputation may include determining that the file has a file type that supports executable data. Modifying the conference experience may include converting the file to a static file type. Determining the reputation of the object may include a cloud query. Modifying the conference experience may include notifying all participants of the web conference. Modifying the conference experience may include blocking access to the object. Modifying the conference experience may include modifying the object. Implementations of the described techniques may include hardware, a method or process, or computer software on a computer-accessible medium.

One general aspect includes one or more tangible. The non-transitory computer-readable storage media also includes initiate a web conference. The media also includes determine that a participant in the web conference has shared an object via the web conference. The media also includes query a cloud service for a reputation for the object. The media also includes receive the reputation. The media also includes according to the reputation, modify a conference experience for at least one participant in the web conference. Other embodiments of this aspect include corresponding computer systems, apparatus, and computer programs recorded on one or more computer storage devices, each configured to perform the actions of the methods.

Implementations may include one or more of the following features. The one or more tangible, non-transitory computer-readable media where modifying the conference experience may include notifying the at least one participant of the reputation. The object is a uniform resource locator (URL). The object is a file. Determining the reputation of the object may include a cloud query. Determining that the object has been shared may include determining that the object was shared via a chat or instant message feature of the web conference. Determining that the object has been shared may include determining that the object was shared via a screen share feature of the web conference. The instructions are further to determine that a remote device participating in the web conference has begun screen recording, and where modifying the conference experience may include notifying the at least one participant of the screen recording. The instructions are further to determine that screen recording has begun on, and where modifying the conference experience may include notifying the at least one participant. The instructions provide a server for the web conference. The instructions provide a client for the web conference. The instructions provide a browser plugin. Modifying the conference experience may include notifying all participants of the web conference. Modifying the conference experience may include blocking access to the object. Modifying the conference experience may include modifying the object. Implementations of the described techniques may include hardware, a method or process, or computer software on a computer-accessible medium.

One general aspect includes a computer-implemented method. The computer-implemented method also includes beginning a web conference. The method also includes determining that an object has been shared via the web conference. The method also includes receiving a reputation for the object. The method also includes according to the reputation, modifying a conference experience for at least one participant in the web conference. Other embodiments of this aspect include corresponding computer systems, apparatus, and computer programs recorded on one or more computer storage devices, each configured to perform the actions of the methods.

Implementations may include one or more of the following features. The method where modifying the conference experience may include notifying the at least one participant of the reputation. The object is a uniform resource locator (URL). The object is a file. Determining the reputation of the object may include a cloud query. Determining that the object has been shared may include determining that the object was shared via a chat or instant message feature of the web conference. Determining that the object has been shared may include determining that the object was shared via a screen share feature of the web conference. Modifying the conference experience may include notifying the at least one participant of the screen recording. Modifying the conference experience may include notifying the at least one participant. The method may include providing a server for the web conference. The method may include providing a client for the web conference. The method may include providing a browser plugin. An apparatus may include means for performing the method. At least one computer readable medium may include instructions that, when executed, implement a method or realize an apparatus. Modifying the conference experience may include notifying all participants of the web conference. Modifying the conference experience may include blocking access to the object. Modifying the conference experience may include modifying the object. Implementations of the described techniques may include hardware, a method or process, or computer software on a computer-accessible medium.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

The COVID-19 pandemic has accelerated the adoption of video conferencing, whether it is for family gatherings, online classes, client meetings, or large conferences. It has resulted in acceptance of this mode of communication for personal as well as work-related collaboration. This behavior change is likely to continue even after the pandemic ends.

As part of collaboration, participants regularly share content during a conference. This content may include links, images, videos, files, documents, and potentially executable content. With widespread usage, the video conference could be exploited as a medium for distribution of malware, even without the knowledge of the attendees. For example, a participant could unknowingly share a link to a “good deal” that is actually a phishing attempt. Or, an attendee could share a malicious office document without realizing that it is infected. It is also possible that one of the attendees is deliberately posting malicious content.

In this environment, it is desirable to protect users from malicious content they may be exposed to during video conferences.

It is also desirable to ensure the confidentiality of content presented in a conference from unauthorized screen and audio recordings when conferencing with groups of people whose trust levels are unknown.

The system and method described in the present disclosure work alongside partnering video applications to provide additional security, privacy, and confidentiality, so that both host and attendees are safe from malicious and untrustworthy content.

In an embodiment, this companion mechanism monitors content that is shared in video conference, such as in a chat interface. The system may then take appropriate remedial action on the content to make the interaction for all participants safe and trustworthy. Actions that the system may take include:
Scanning files and documents shared in the chat interface for reputation to detect malware
Scanning URLs for reputation to detect malicious links
Providing intelligence on trustworthiness of URLs with respect to privacy, security, data risk, etc.

Once malicious, suspicious, untrustworthy, or undesirable content is identified, remedial action may be taken to keep the users' interaction with the content safe. Illustrative and nonlimiting examples of remedial action include, by way of illustrative and nonlimiting example:
Tagging posts with a reputation of the content. This enables community scanning, even if a client has no capability to scan for reputation.
URLs that are malicious may be blocked by a client in the browser.
Contextual advice may be provided to users on the trustworthiness of URLs by a client in the browser.
A utility may convert certain documents that can potentially be harmful into a safe or static format without any dynamic content (e.g., PDF, XPS, TIFF, or similar).
Information may be given on trustworthiness of URLs with respect to privacy, security, data risk, etc.

The system also helps to ensure that privacy and confidentiality of presented content in the video conference is safeguarded from possible malicious screen recorders and web scrapers.

In an illustrative embodiment, a companion mechanism (such as a software application) monitors the system for any screen recording that might be occurring. The host and/or presenter is informed of the status of each participant, whether participants are using the companion mechanism or a compatible monitoring client, and whether any of the participants has screen recording running during the conference proceedings.

In an example, the system uses a heuristics-based method of detecting whether confidentiality is compromised by detecting screen recording, audio recording, and shared clipboard access.

This system realizes advantages over certain existing solutions. For example, video conference platforms catering to enterprises may assume the security, privacy, and confidentiality of clients, for example because the participants are using authenticated sessions. In the consumer scenario, where video conferencing is used with a large number of participants whose trust levels are unknown, existing tools may fall short in ensuring security, privacy, and confidentiality.

The combination of components and techniques in the present disclosure provides an improvement over previously-known structures and techniques. In an example, the system may include a videoconference client agent, backend platform, and software development kit to integrate into an existing conference backend infrastructure.

This provides services for file and URL reputation, extension reputation, URL trustworthiness reputation, and utilities to convert documents to a safe format. Also, browser plugins may be used to block malicious links and provide contextual trustworthiness scores for links, as well as detecting screen conference recording.

Applications with capability for screen recording may be identified by performing static analysis of the binary to detect all possible application programming interfaces (APIs) used for screen recording.

Dynamic detection may be performed by using DirectX events to monitor frame buffer grabbing and detect video encoding, system-level audio capture, and audio encoding.

Hybrid techniques may also be used, including heuristic analysis of system activity to detect if any screen recording is in progress (including monitoring of parameters like DirectX events, as well as video and audio encoding).

For browser-based conference sessions, a browser plugin may detect extensions that perform screen recording and/or document object model (DOM) scraping, and contextually disable these extensions. The system may use existing extension reputation technology to detect these extensions. Contextually disabling the extensions may include disabling the extensions only on certain uniform resource locators (URLs) or in other contexts, while allowing them to run in other contexts. Thus, the browser plugin does not interfere with the user's regular interaction with the web browser, but rather provides URL- or application-specific limitations that help to protect the security and privacy of all participants.

Embodiments of the present disclosure may also identify applications that have a capability for screen recording using static analysis of the binary to detect APIs used for screen recording. When a conference is active, the system may detect system-level audio capture, and perform heuristic analysis of the system activity.

For browser-based conference sessions, a browser plugin may detect extensions that perform screen recording and/or DOM scraping and contextually disable these extensions. The system may use existing extension reputation technology to detect these extensions.

Furthermore, an agent may communicate the status of a participant's system within a video conference. Using elements of the present disclosure, hosts and/or presenters may be informed of the security status of each client's environment.

A system and method for providing enhanced web conference security will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

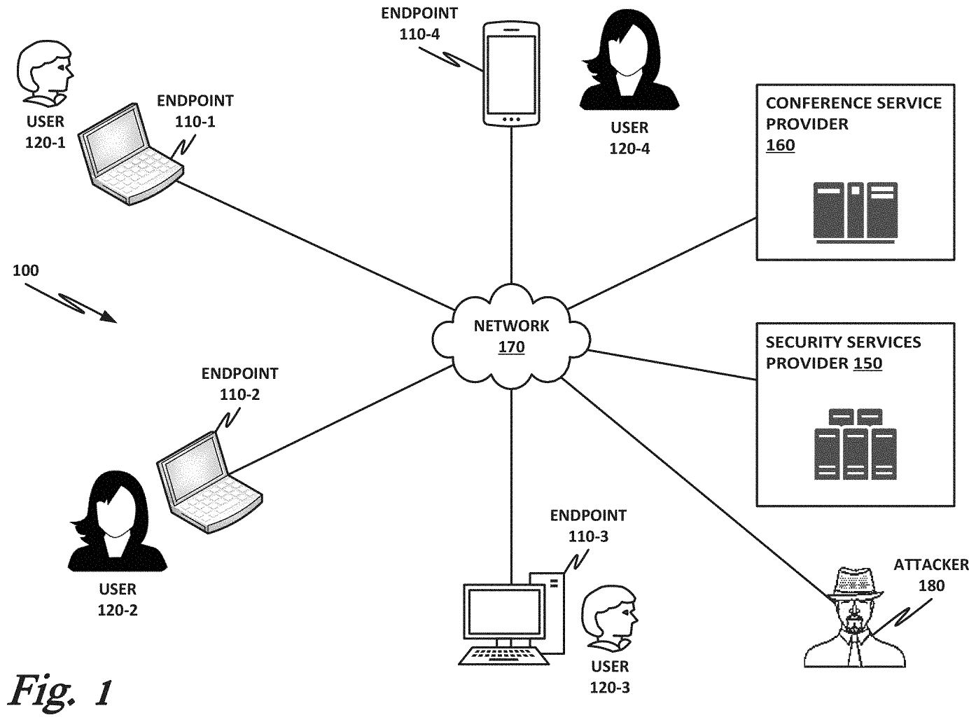

FIG. 1 is a block diagram of selected elements of a web conference ecosystem 100. Web conference ecosystem 100 includes a plurality of users 120 operating a plurality of endpoint devices 110. Specifically, user 120-1 operates endpoint 110-1. User 120-2 operates endpoint 110-2. User 120-3 operates endpoint 110-3. User 120-4 operates endpoint 110-4. Endpoints 110 communicatively couple to one another and to the web conference via network 170.

Endpoint devices 120 may be various types of internet-capable devices, such as by way of illustrative and nonlimiting example, desktop computers, laptop computers, workstations, servers, smartphones, tablets, convertible tablets, and others.

A conference service provider 160 provides web conferencing services to users 120 via endpoints 110. This allows users 120 to form audio and video connections with one another, to share screens, share documents, share links, and perform other interactions. Illustrative and nonlimiting examples of web conference services include Zoom, Microsoft Teams, WebEx, and others. Some chat services also provide more limited web conference features, such as Jabber, ICQ, XMPP, NextCloud, Slack, MatterMost, or others. Conference security provider 160 could be a publicly available service operated by a large vendor (e.g., Zoom, Teams, WebEx, or Slack) or it could be a private cloud operated by an enterprise or by one of the participants in the web conference. Hybrid solutions are also available, such as private cloud versions of web conference servers provided by larger vendors.

Security services provider 150 may interoperate with conference service provider 160 and/or endpoints 110 to enhance the security of a web conference. For example, security services provider 150 may provide an API or SDK that plugs into the public or private cloud service provided by conference service provider 160. The API or SDK may extend the functionality of the conference service, such as by providing enhanced security as described in this specification. Security services provider 150 may also provide a web conference client to endpoints 110 or, alternatively, an extension that plugs into an existing web conference client to enhance the security thereof. In cases where endpoints 110 access the web conference via a website on a browser, security services provider 150 may provide an extension such as a browser plug-in that enhances security. In general terms, security services provider 150 may provide for endpoints 110 either a standalone application or an extension, plug-in, or other add-on to an existing application that provides the enhanced security features described herein. In general terms, the software and/or extension provided on the endpoint may be referred to as a video conference client, whereas the software, SDK, and/or API provided to conference service provider 160 may be referred to as a backend platform, which may integrate into the conference backend infrastructure.

The videoconference client agent and backend platform may provide services for file and URL reputation, extension reputation, URL trustworthiness, reputations for other objects, and utilities to convert documents or objects to a safe format by way of illustrative and nonlimiting example.

For example, in cases where the endpoint agent is a browser plug-in, the browser plug-in may block certain links, either in gross or based on URL reputations and may also provide contextual trustworthiness scores for links. In some cases, the browser extension may also contextually block certain other browser extensions, such as by sending a cloud-based query to security services provider 150 to query security services provider 150 for a reputation for the other browser extension. Upon receiving the reputation, the endpoint agent browser extension may determine whether the other browser extension is contextually allowable. This may include more than just a general reputation for trustworthiness or a safety for the extension. For example, if the other extension has web scraping or screen recording capabilities, then even if it is considered safe in the abstract, in the context of a web conference, it may represent a threat vector because a user may perform screen captures or screen recording without the knowledge of other participants. Thus, one user 120 may represent a privacy or security threat to other users 120. In other cases, an attacker 180 could inject malicious code into one of the endpoint devices 110. Attacker 180 could use the malicious code to perform web scrapes or screen captures of the conference without the knowledge of the user operating the endpoint device. Thus, outside attackers 180 may also represent a threat to the web conference safety, privacy, or security.

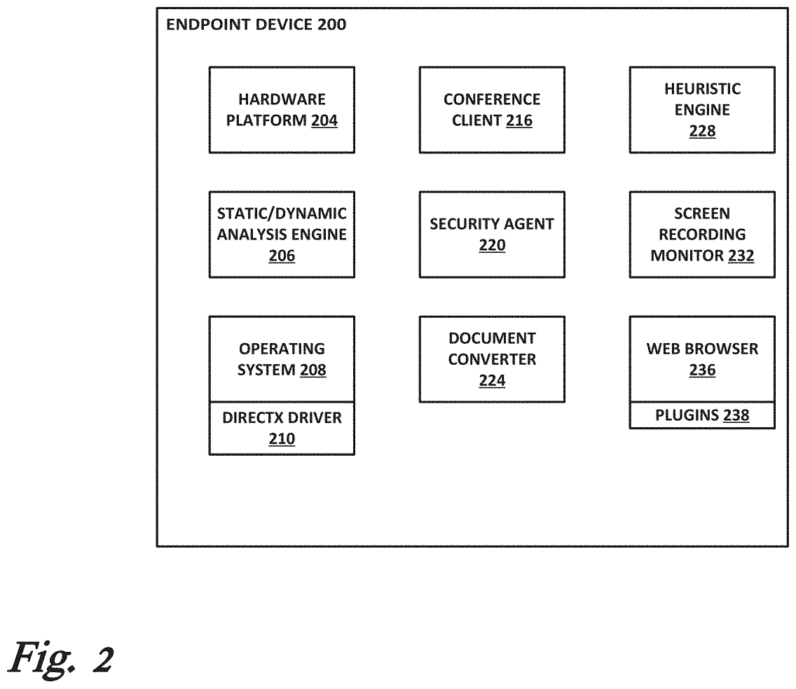

FIG. 2 is a block diagram of an endpoint device 200. Endpoint device 200 may be considered an example or an embodiment of an endpoint 110 of FIG. 1 or may be a separate device.

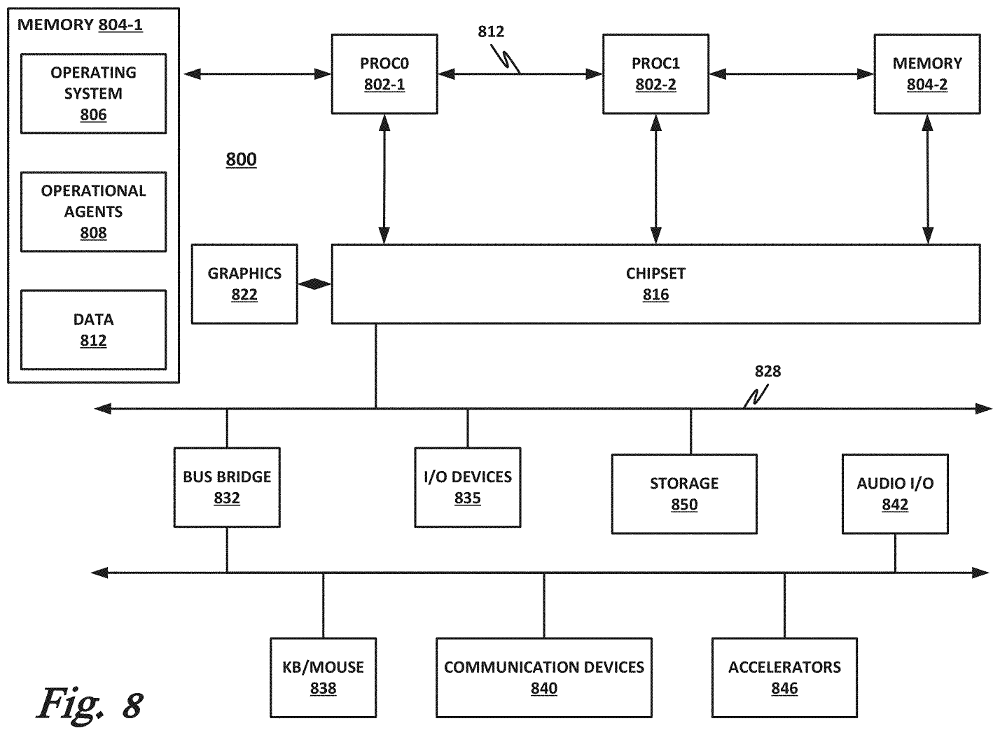

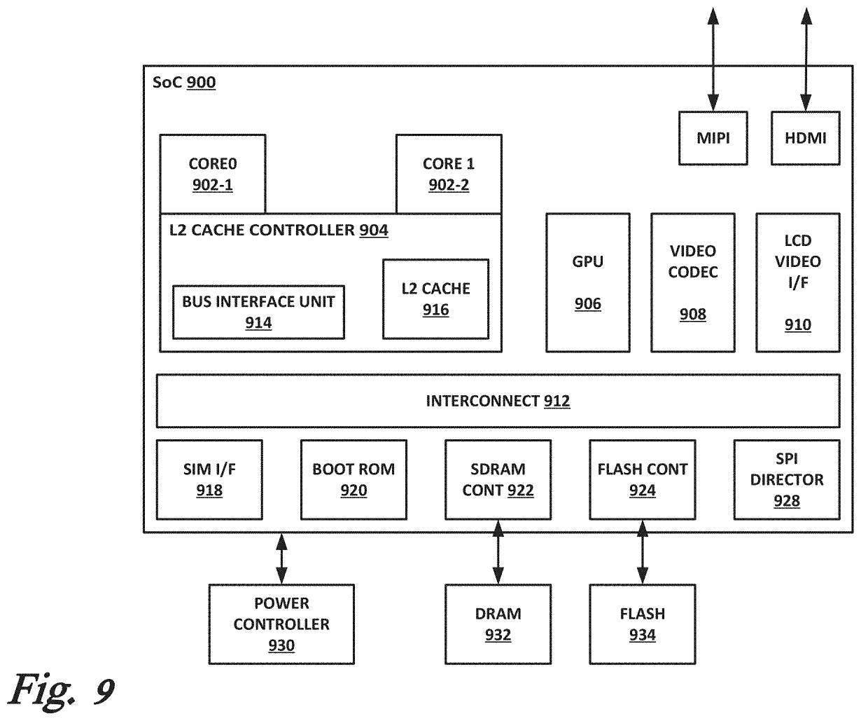

Endpoint device 200 may include a hardware platform 204. Illustrative examples of hardware platforms are shown in FIGS. 8 and 9 below. This may include, for example, a processor and a memory, which may be a static and/or dynamic memory or a combination thereof. The memory may have stored thereon executable instructions that, when executed, instruct the processor to carry out certain functions or provide certain modules or engines.

In this example, software running on endpoint device 200 includes a conference client 216. Conference client 216 may provide the user access to a web conference, such as via a dedicated connection. Alternatively, a web browser 236 may provide web-based access to a web conference. Web browser 236 may include one or more plug-ins 238. Plug-ins 238 are extensions or add-ons to the web browser and may provide extended functionality. As described above, the client software may include a web extension and may also include enhanced security functionality. The enhanced security functionality may be the same plug-in as the web conference plug-in or may be a separate plug-in.

In general terms, the enhanced security features described herein may be embodied within security agent 220, whether security agent 220 is a standalone, separate program or a part of conference client 216, plug-ins 238, or some other software. Security agent provides additional features, such as a static/dynamic analysis engine 206, a screen recording monitor 232, a heuristic engine 228, and a document converter 224. Security agent 220 runs on an operating system 208, which may include a DirectX driver 210.

Security agent 220 provides useful functions for the web conference. For example, security agent 220 may detect when a particular object has been shared with the conference. This object may include, for example, a link or document shared via the chat function or a link shared via the screen share function. The sharing of the object may also include any other mechanism used to broadcast information to one or more participants of the web conference.

Security agent 220 may contextually analyze the shared object and act accordingly. For example, if the shared object is a URL, security agent 220 may query a reputation service such as a cloud-based reputation service for a reputation of the URL. McAfee GTI provides such a reputation service for URLs. The reputation service may also provide reputations for other objects, such as files, file types, web browser extensions, and others. Indeed, security agent 220, in addition to providing the enhanced features for the web conference, could also be a general security agent that provides antivirus, anti-malware, anti-spyware, or other security features for endpoint device 200.

When security agent 220 determines that an object has been shared to the conference after receiving a reputation for the object, security agent 220 may act accordingly on the reputation. In one example, security agent 220 determines that the object has a negative or unsafe reputation and modifies the conference experience for one or more participants in the web conference. For example, security agent 220 may block the unsafe object on the local endpoint device 200. Security agent 220 could also notify the web conference server software of the unsafe object. The web conference server may also include extensions that enhance the security of the web conference. For example, when security agent 220 notifies the web conference server of the negative reputation, the web conference server may block the object for all participants in the web conference or may provide a warning along with the object, depending on the severity of the negative reputation. In other cases, if the object is determined to have a good or safe reputation, a modification of the conference experience could be placing a positive indicator next to the object, such as a green checkmark or similar.

In some cases, the object shared may be a document, an executable file, or other similar file. If the object is determined to be a file, security agent 220 may perform a scan on the object, such as by performing a traditional antivirus, anti-malware, or anti-spyware scan on the device. This may optionally include querying a cloud service for a reputation of the object or permitting a cloud-based service with a larger database of objects and greater processing capability to perform a more detailed analysis of the file. For example, conference service provider 160 may include an API or plug-in that provides the backend platform of the web conference and that interacts with security services provider 150.

The backend platform may provide the shared file to security services provider 150 which may then perform a detailed or in-depth scan on the file, which may affect whether the file is shared, blocked, modified, or indicated safe. In one example, if the file does not have a reliable safe reputation, then it may be converted to another format, such as a static format that prevents the execution of embedded and possibly malicious code or macros in the file. For example, if the file is a Microsoft Word document, an Excel spreadsheet, or other file or document format that supports executable content or macros, document converter 224 may convert the document to a static file format such as PDF, XPS, TIF, JPEG, PNG, or similar. Thus, users may gain access to the content of the document without the risk of being exposed to possibly malicious code.

Another valuable function in the extended security of the web conference ecosystem is the detection of screen sharing. Screen recording is a risk because when the screen or audio is recorded by one user without the knowledge of other users, then personal or enterprise information may be compromised without the participants' knowledge. Static/dynamic analysis engine 206, heuristic engine 228, screen recording monitor 232, and DirectX driver 210 may all have a part to play in identifying screen recording. For example, static/dynamic analysis engine 206 may perform either static or dynamic analysis of the system to identify when screen recording may be occurring.

In static analysis, the agent may identify applications that have this capability to perform screen recording. This may include, for example, performing static analysis of the binary to detect all possible APIs or capabilities that may be used for screen recording. When the conference is active, the static/dynamic analysis engine 206 may then detect if any these applications are actively running. If they are running, then an appropriate action may be taken. For example, a notification may be pushed out to the web conference so that all users are aware that a screen recording has begun. The screen recording applications may be blocked while the web conference is active and/or has focus, thus preventing any screen recording that does not occur via the conference client 216. Alternatively, security agent 220 could notify conference service provider 160 of FIG. 1 when screen recording is active, and then appropriate action may be taken, such as by pausing screen sharing, notifying users, or taking some other action to modify the web conference experience.

Dynamic analysis may include, for example, using an operating system API, such as DirectX or similar, to monitor frame buffer grabbing dynamically. This can be used to detect video encoding. Static/dynamic analysis engine 206 may also be used to detect system-level audio capture and audio encoding. These can indicate that screen recording or audio capture is occurring, even in the absence of static analysis.

Heuristic engine 228 may also provide a hybrid approach. For example, heuristic analysis of the system activity and detected applications may be used to determine if screen recording is in progress. Heuristic engine 228 may monitor parameters such as DirectX events, video recording, audio encoding, and other similar events that may contextually indicate that screen recording is occurring.

For browser-based conference sessions, heuristic engine 228 may be included with a plug-in 238. The browser plug-in may detect extensions that do screen recording and/or document object model (DOM) scraping. In some cases, detecting these extensions may include querying a cloud-based extension reputation service for the extensions. If such extensions are detected, then security agent 220 may contextually disable those extensions when the web conference is in session.

Heuristic engine 228 may also identify applications that have the ability to screen record, such as via static analysis of the binaries to detect APIs used for screen recording. When the web conference is active, any such applications may be monitored and/or optionally disabled to determine whether screen recording is occurring.

Heuristic engine 228 may also detect system-level audio capture and use this information to infer screen or audio recording. Furthermore, if an application is active that has screen recording or audio capture capabilities, but also has other capabilities, then it is possible that the application is being used for other purposes. Thus, even if static analysis determines that an application has the APIs necessary to perform screen recording or audio capture, heuristic analysis may be used to determine whether such is occurring when the application is open.

In monitoring the web conference, security agent 220 may communicate the status of the participant system to the videoconference server provided by the backend platform. The backend platform may then provide the hosts and presenters of the status of the conference environment.

Furthermore, in some cases, security agent 220 may communicate directly with other endpoints if there is determined to be a security risk. For example, if an object is shared with only one user via a chat function, then security agent 220 may notify the other endpoint device if a negative reputation is found for an object, if screen recording has begun on the endpoint or if contextually important activities happen.

In some cases, this communication relies on the presence of a similar security agent on other endpoint devices. So security agent 220 may scan, query, or poll other participants in the web conference to determine which participants have a similar security agent that provides enhanced features. If any of the participants are found not to have an appropriate security agent, then appropriate action may be taken. For example, links or objects shared from those endpoints may be blocked or subjected to enhanced scrutiny and screen sharing may not be served to that unprotected endpoint. Furthermore, users or participants in the web conference may be notified that there is a participating endpoint that does not provide the enhanced security, and those users may take appropriate action or safety measures.

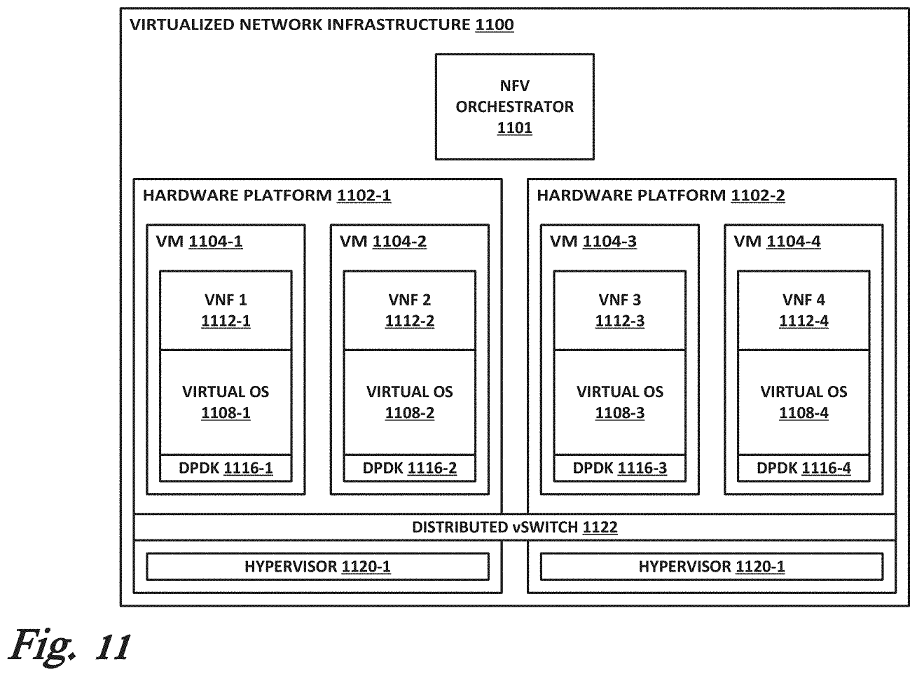

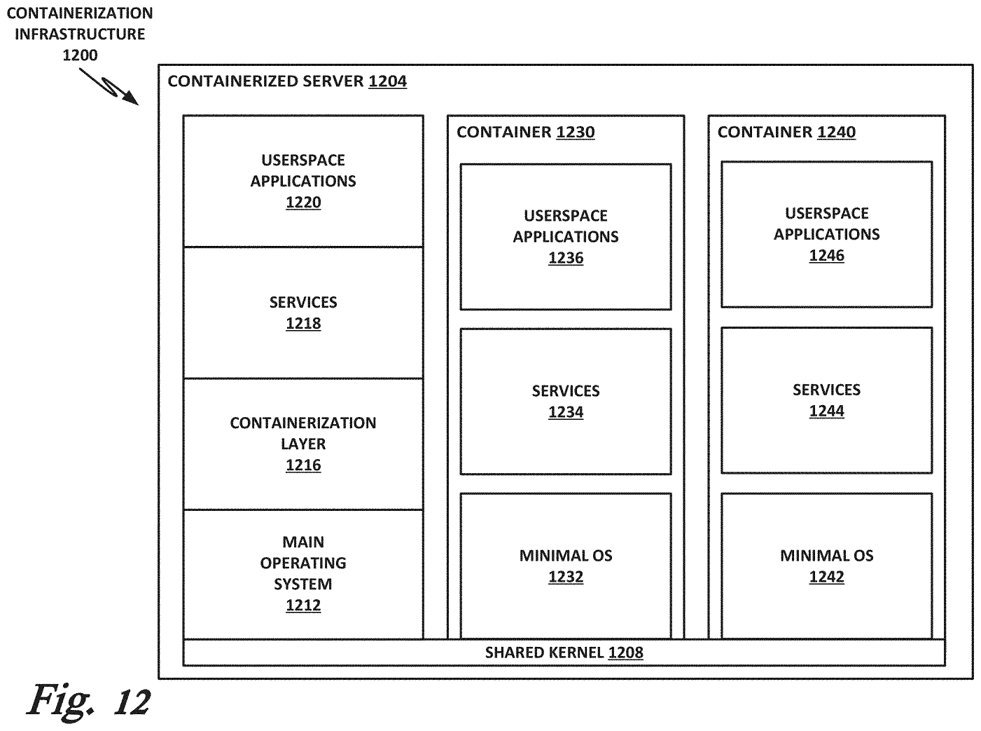

Certain functions of a backend platform have been described in connection with endpoint device 200. While it is possible for endpoint device 200 to provide these functions itself, it is more common for those functions to be provided on a private or public cloud. In that case, the various functions may be provided via a cloud infrastructure, such as a hardware platform as illustrated in FIG. 8 or FIG. 9, which may provide a virtualization or guest platform as illustrated in FIG. 11, and/or containerization as illustrated in FIG. 12.

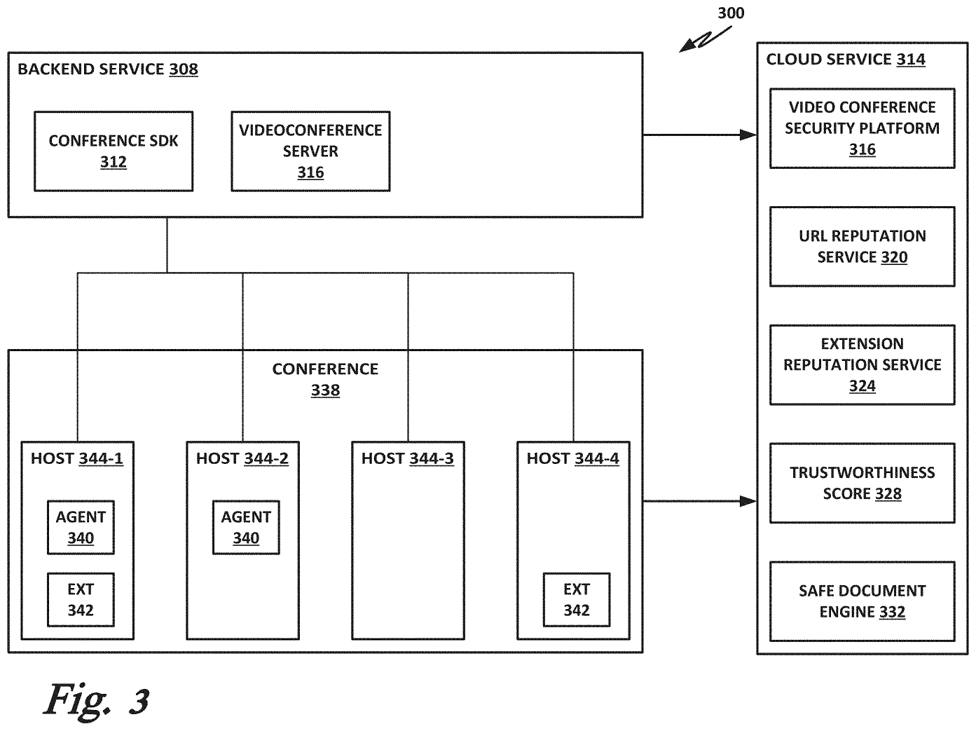

FIG. 3 is a block diagram of selected elements of a web conference 300. Web conference 300 includes a backend service 308, a conference 338, including a plurality of hosts 344, and a cloud service 314. These elements are disclosed and illustrated by way of nonlimiting example, and in other embodiments, additional elements may presence, while in other embodiments, some or all of the elements shown may be omitted as appropriate.

Backend service 308 is a service provided, for example, by conference service provider 160 of FIG. 1. Backend service 308 provides the actual web conference implementation that enables hosts 344 to join conference 338. The use of a backend service 308 is common but not necessary. For example, it is also possible, in some cases, for hosts 344 to communicatively couple via peer-to-peer technology. In that case, a backend service 308 may be omitted.

Backend service 308 provides videoconference server 316. Videoconference server 316 provides the software and interfaces to host conference 338. Backend service 308 also includes a conference SDK 312. Conference SDK 312 may, in some cases, be provided by a third party, such as by security services provider 150 of FIG. 1. Conference SDK may be provided to implement the enhanced security features of the present specification. For example, conference SDK 312 may receive notifications from hosts 344 of active or ongoing screen recording or other activity that is of interest to the conference. Furthermore, videoconference server 316 may receive shared content or shared objects, such as a shared file or URL. Conference SDK 312 may query cloud service 314 for a reputation for the object, and upon receiving a reputation for the object, perform an appropriate remedial action as necessary. This remedial action may include modifying the conference experience for the users operating the endpoint devices 344. For example, conference SDK 312 could provide warnings associated with links, block links, convert a document from one format to another format, or otherwise block certain hosts 344, modify the experience for certain hosts 344 (e.g., such as disabling screen sharing to a host 344-3 that lacks an appropriate end-user agent), or perform other similar action.

Cloud service 314 may be implemented locally with backend service 308, on a hosts 344, or remotely in a cloud operated by a third party. Cloud service 314 includes a videoconference security platform 316, a URL reputation service 320, an extension reputation service 324, a trustworthiness score 328, and a safe document engine 332. By way of example, videoconference security platform 316 may provide appropriate interfaces for communicating with conference SDK 312 as well as agents 340 or extensions 342 of the various hosts 344. Videoconference security platform 316 may provide the interfaces or APIs (such as REST interfaces) or other logical data interfaces that receive messages and send responses.

URL reputation service 320 may be configured to receive, via videoconference security platform 316, messages identifying a particular URL, such as a URL that has been shared via the conference either in a chat message or via screen sharing. URL reputation service 320 may then query a URL reputation database to determine a reputation for the URL if a reputation is known. If the URL has a known reputation, then URL reputation service 320 may return the reputation to conference SDK 312 or to an appropriate agent 340 or extension 342. If the URL does not have a known reputation, then URL reputation service 320 may take steps to analyze the URL and determine a reputation. URL reputation service 320 may then return to the conference SDK 312, agent 340, or extension 342 an appropriate response, such as a response that the URL does not have a known or valid reputation, that a reputation could or could not be determined, and if reputation was determined, the reputation itself.

Extension reputation service 324 may also interact with conference SDK 312, agent 340, or extension 342. Extension reputation service 324 may receive a query for a reputation for an extension to a web browser and may then query an extension reputation database to determine a reputation for the extension. As in the case of a URL, if the extension does not have a known reputation, then further analysis may optionally be performed and an appropriate response is returned.

Trustworthiness score 328 is a module that returns a trustworthiness score for any of the objects disclosed herein. This could include a URL reputation, an extension reputation, a file reputation, a file type reputation, or a reputation for any other object encountered in the network. Trustworthiness score 328 may be determined by querying an appropriate database or by in-depth analysis of the object in real-time or near real-time. In some cases, where trustworthiness score 328 cannot be returned immediately, an unknown reputation will be temporarily returned and that reputation may be updated after a better reputation has been determined or the next time a query is made to the same object.

Safe document engine 332 may provide options for safely handling documents, files, or other objects that are shared via the web service. For example, if a user posts a Microsoft Word document in the chat function or shares it via the web conference, then conference SDK 312 may share the document with cloud service 314. Cloud service 314 may then convert the document to a safer format, such as a static format that poses less risk to the end-users' machines. Note that in some cases, sharing the document to cloud service 314 may be seen as a privacy or security risk. For example, it may be undesirable, from a privacy standpoint, to upload the document to cloud service 314. In those cases, a safe document engine 332 may be provided as part of conference SDK 312 or locally on hosts 344.

Conference 338 has a number of participating endpoints, including host 344-1, host 344-2, host 344-3, and host 344-4. These various hosts may have different configurations in terms of security enhancements. For example, host 344-2 has a single security agent 340. Security agent 340 may include the conference software, which means that the user receives protection so long as the user uses the conference software to access the web conference. If the user instead uses a web browser to access the web conference, agent 340 may be limited in its ability to provide safety and security. This is particularly true in cases of an operating system, such as iOS, that is a closed operating system and that provides sandbox runtime environments for each application. In that case, agent 340 would not have visibility into the web browser and, thus, is limited in the safety and security applications it's provided. Conference SDK 312 and agents 340 operating on other endpoints may make appropriate decisions based on the presence or absence of an enhanced security feature on a particular device. For example, conference SDK 312 could modify the web conference experience for host 344-2, could block certain content, could warrant other users that host 344-2 lacks some security functions, or could otherwise provide appropriate action.

Host 344-3 may be an even greater security concern because this host lacks any of agent 340 or extension 342. Thus, this endpoint receives no endpoint level protection regardless of whether the user accesses the conference via a web interface or via a standalone application.

Host 344-4 has a browser extension 342, but lacks a standalone security agent 340. In this case, enhanced security is provided if the user accesses the conference via the web interface, but not if the user accesses the conference via a standalone application. Again, appropriate remedial action may be taken.

Host 344-1 has both a standalone agent 340 and a browser extension 342. In some cases, this represents the best available protection, as this means that the house 344-1 receives enhanced security whether the user accesses the conference via the web interface or via the standalone application.

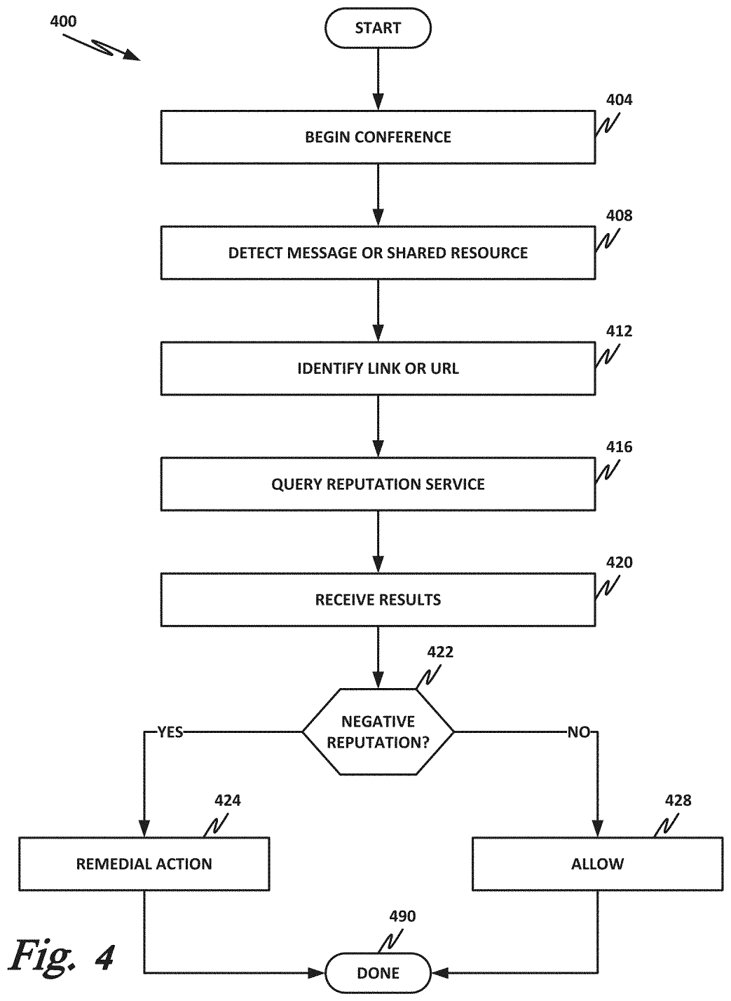

FIG. 4 is a block diagram of a method 400. The 400 may be performed, for example, by a host 344 of FIG. 3, a backend service 308 of FIG. 3, and/or a cloud service 314 of FIG. 3.

In block 404, the web conference begins operation.

In block 408, the system detects a message or a shared resource. This could include, for example, detecting that a URL or file has been shared via a chat or instant message function, detecting that a URL was shared on a screen, or otherwise determining that an object has been shared in the web conference.

In block 412, the system characterizes the object, such as identifying a link or URL, a file, a file type, or otherwise characterizing the device.

In block 416, the system queries a reputation service. This could include a cloud query to a remote service or a local query to a local service.

In block 420, the system receives the query result from the reputation service.

In block 422, the system determines whether the object was assigned a negative reputation by the reputation service.

If a negative reputation was given, then in block 424, the system may take any appropriate remedial action, such as blocking the object, warning the user, converting the object to a different format, such as a static format, or taking any other appropriate remedial action.

Returning to decision block 422, if no negative reputation was received, and the object is deemed safe, then in block 428, the object is allowed.

In block 490, the method is done.

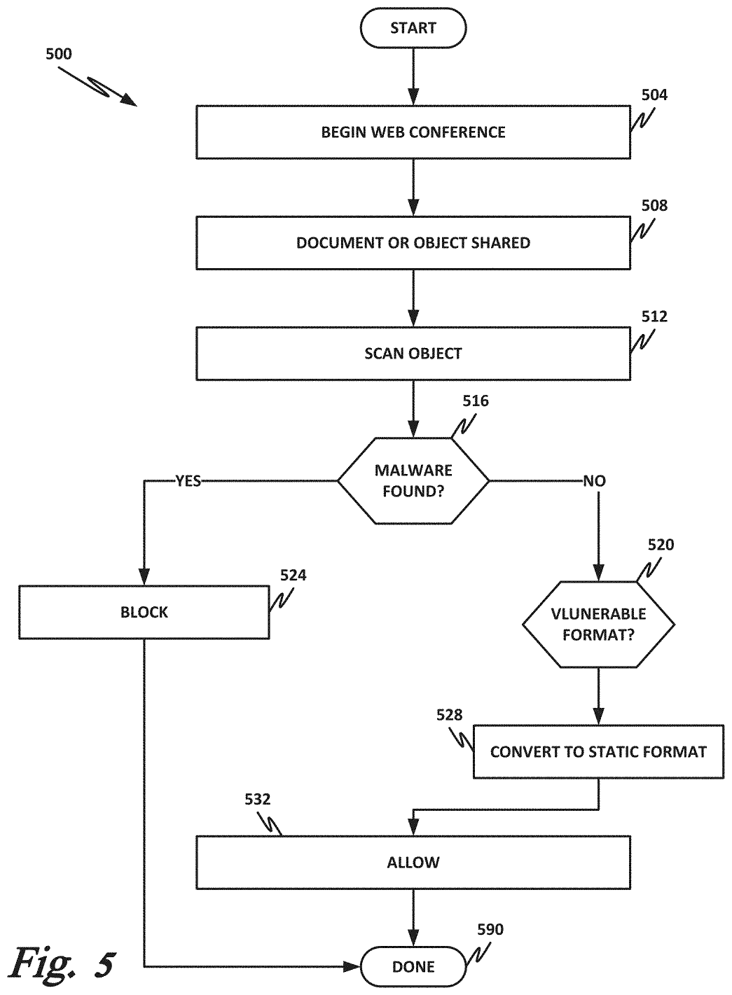

FIG. 5 is a flowchart of a method 500. As with method 400, method 500 may be performed on any suitable device as disclosed in the specification.

In block 504, the web conference begins.

In block 508, the system determines that a document, file, or other file-like object has been shared via the web conference.

In block 512, the system may scan the document to determine whether it contains identifiable or recognizable malware.

If malware is found, then in block 524, the document or object is blocked.

Returning to decision block 516, if no malware is found, then in block 520, the system determines whether the file has a vulnerable format. For example, if the file has a format like DOCX, PPTX, XLSX, EXE, DLL, or other similar extensions that permit the execution of code or instructions, the format may be deemed vulnerable. In that case, it may be safer to convert the document to a format that lacks such executable capabilities.

In block 528, the system may convert the object to a static format, such as a PDF, XPS, TIF, other image format, plain text, or similar.

In block 532, after converting the object to an appropriate format, the object is allowed to be shared on the web conference, and is accessible to other participants.

In block 590, the method is done.

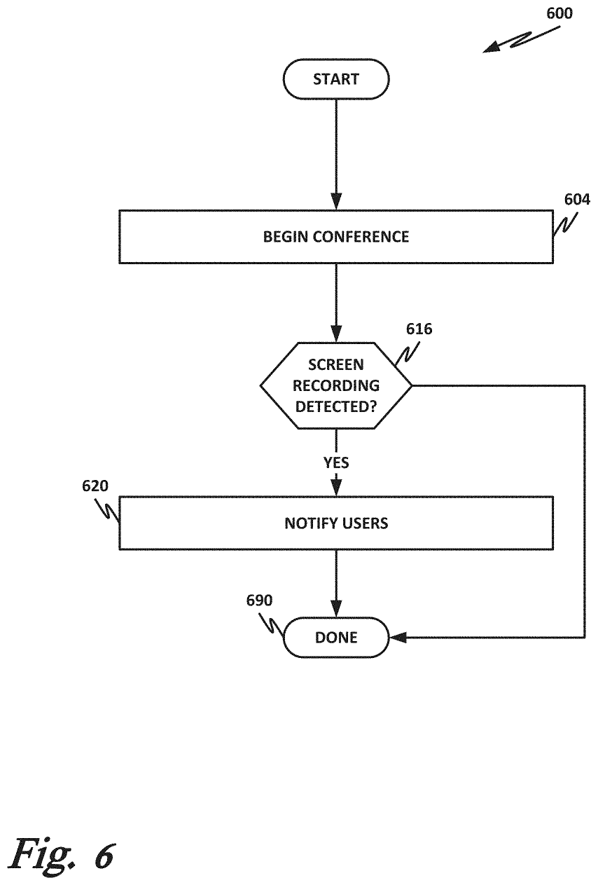

FIG. 6 is a flowchart of a method 600. As with the other methods disclosed herein, method 600 may be performed by any of the appropriate devices disclosed herein.

In block 604, the conference begins. In block 616, the system monitors to detect whether screen recording is occurring.

If no screen recording occurs, then no action needs to be taken. However, if screen recording does occur, then in block 620, the system may notify users or participants in the web conference. Other remedial action may also be taken in addition to or instead of notifying the users. For example, the host that is attempting screen recording could be blocked from shared screen or audio feeds while the screen recording is ongoing or other measures could be taken to protect users' security and privacy.

In block 690, the method is done.

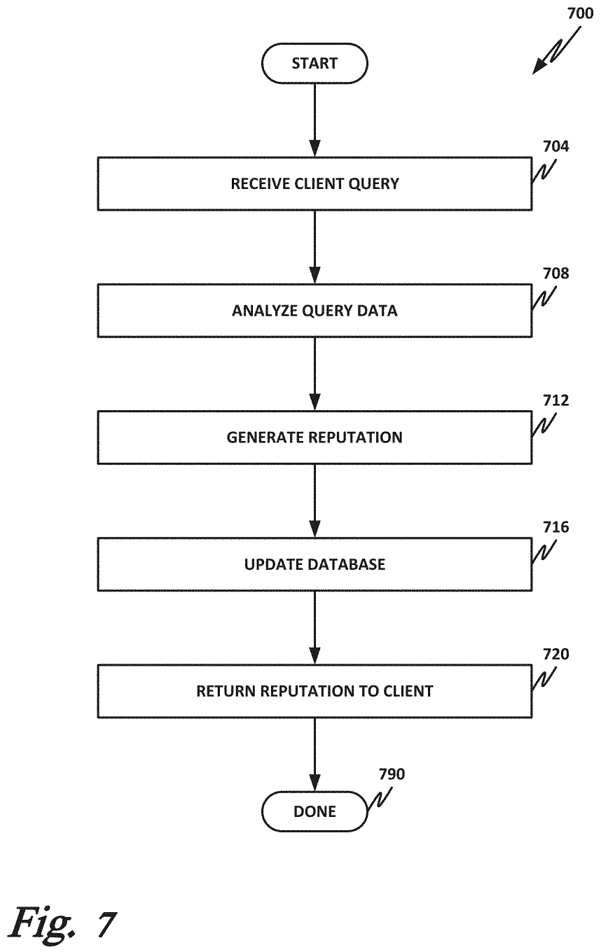

FIG. 7 is a flowchart of a method 700. Method 700, as with the other methods disclosed herein, may be performed by any of the appropriate systems or devices disclosed herein. Method 700, in particular, illustrates handling of queries or requests from a client.

In block 704, the system receives a client query. For example, the client query could be a request for a URL reputation, a file reputation, an extension reputation, or other query.

In block 708, the system analyzes the query data. This could include querying a database for a known reputation, analyzing the object for a reputation if a known reputation is not found (or if it is desirable to augment the known reputation), or otherwise acting on the data to determine reputation for the data.

In block 712, the system generates the reputation, such as by receiving a response from the reputation database, generating the reputation from analysis, a combination of the two, or any other appropriate action.

In block 716, the system may update its own reputation databases so that future queries will have greater accuracy and more information for receiving a reputation.

In block 720, the system returns the reputation to the querying client.

In block 790, the method is done.

FIG. 8 is a block diagram of a hardware platform 800. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 800, even though they may be scattered across a data center, or even located in different data centers.

Hardware platform 800 is configured to provide a computing device. In various embodiments, a “computing device” may be or comprise, by way of nonlimiting example, a computer, workstation, server, mainframe, virtual machine (whether emulated or on a “bare-metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 800 is arranged in a point-to-point (PtP) configuration. This PtP configuration is popular for personal computer (PC) and server-type devices, although it is not so limited, and any other bus type may be used.

Hardware platform 800 is an example of a platform that may be used to implement embodiments of the teachings of this specification. For example, instructions could be stored in storage 850. Instructions could also be transmitted to the hardware platform in an ethereal form, such as via a network interface, or retrieved from another source via any suitable interconnect. Once received (from any source), the instructions may be loaded into memory 804 (e.g., memory 804-1 and/or 804-2), and may then be executed by one or more processor 802 to provide elements such as an operating system 806, operational agents 808, or data 812.

Hardware platform 800 may include several processors 802. For simplicity and clarity, only processors PROC0 802-1 and PROC1 802-2 are shown. Additional processors (such as 2, 4, 8, 16, 24, 32, 64, or 128 processors) may be provided as necessary, while in other embodiments, only one processor may be provided. Details of processors 802 are not illustrated in this FIGURE, but one embodiment is illustrated in FIGURE QD. Processors may have any number of cores, such as 1, 2, 4, 8, 16, 24, 32, 64, or 128 cores.

Processors 802 may be any type of processor and may communicatively couple to chipset 816 via, for example, PtP interfaces. Chipset 816 may also exchange data with other elements, such as a high-performance graphics adapter 822. In alternative embodiments, any or all of the PtP links illustrated in FIG. 8 could be implemented as any type of bus, or other configuration rather than a PtP link. In various embodiments, chipset 816 may reside on the same die or package as a processor 802 or on one or more different dies or packages. Each chipset may support any suitable number of processors 802. A chipset 816 (which may be a chipset, uncore, Northbridge, Southbridge, or other suitable logic and circuitry) may also include one or more controllers to couple other components to one or more CPUs.

Two memories, 804-1 and 804-2 are shown, connected to PROC0 802-1 and PROC1 802-2, respectively. As an example, each processor is shown connected to its memory in a direct memory access (DMA) configuration, though other memory architectures are possible, including ones in which memory 804 communicates with a processor 802 via a bus. For example, some memories may be connected via a system bus, or in a data center, memory may be accessible in a remote DMA (RDMA) configuration.

Memory 804 may include any form of volatile or nonvolatile memory including, without limitation, magnetic media (e.g., one or more tape drives), optical media, flash, random access memory (RAM), double data rate RAM (DDR RAM) non-volatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 804 may be used for short, medium, and/or long-term storage. Memory 804 may store any suitable data or information utilized by platform logic. In some embodiments, memory 804 may also comprise storage for instructions that may be executed by the cores of processors 802 or other processing elements (e.g., logic resident on chipsets 816) to provide functionality.

In certain embodiments, memory 804 may comprise a relatively low-latency volatile main memory, while storage 850 may comprise a relatively higher-latency nonvolatile memory. However, memory 804 and storage 850 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 804 and storage 850, for example, in a single physical memory device, and in other cases, memory 804 and/or storage 850 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 822 may be configured to provide a human-readable visual output, such as a command-line interface (CLI) or graphical desktop such as Microsoft Windows, Apple OSX desktop, or a Unix/Linux X Window System-based desktop. Graphics adapter 822 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 822 may include a hardware graphics card, which may have its own memory and its own graphics processing unit (GPU).

Chipset 816 may be in communication with a bus 828 via an interface circuit. Bus 828 may have one or more devices that communicate over it, such as a bus bridge 832, I/O devices 835, accelerators 846, communication devices 840, and a keyboard and/or mouse 838, by way of nonlimiting example. In general terms, the elements of hardware platform 800 may be coupled together in any suitable manner. For example, a bus may couple any of the components together. A bus may include any known interconnect, such as a multi-drop bus, a mesh interconnect, a fabric, a ring interconnect, a round-robin protocol, a point-to-point interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 840 can broadly include any communication not covered by a network interface and the various I/O devices described herein. This may include, for example, various USB, FireWire, Lightning, or other serial or parallel devices that provide communications.

I/O Devices 835 may be configured to interface with any auxiliary device that connects to hardware platform 800 but that is not necessarily a part of the core architecture of hardware platform 800. A peripheral may be operable to provide extended functionality to hardware platform 800, and may or may not be wholly dependent on hardware platform 800. In some cases, a peripheral may be a computing device in its own right. Peripherals may include input and output devices such as displays, terminals, printers, keyboards, mice, modems, data ports (e.g., serial, parallel, universal serial bus (USB), Firewire, or similar), network controllers, optical media, external storage, sensors, transducers, actuators, controllers, data acquisition buses, cameras, microphones, speakers, or external storage, by way of nonlimiting example.

In one example, audio I/O 842 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 832 may be in communication with other devices such as a keyboard/mouse 838 (or other input devices such as a touch screen, trackball, etc.), communication devices 840 (such as modems, network interface devices, peripheral interfaces such as PCI or PCIe, or other types of communication devices that may communicate through a network), audio I/O 842, a data storage device 844, and/or accelerators 846. In alternative embodiments, any portions of the bus architectures could be implemented with one or more PtP links.

Operating system 806 may be, for example, Microsoft Windows, Linux, UNIX, Mac OS X, iOS, MS-DOS, or an embedded or real-time operating system (including embedded or real-time flavors of the foregoing). In some embodiments, a hardware platform 800 may function as a host platform for one or more guest systems that invoke application (e.g., operational agents 808).

Operational agents 808 may include one or more computing engines that may include one or more nontransitory computer-readable mediums having stored thereon executable instructions operable to instruct a processor to provide operational functions. At an appropriate time, such as upon booting hardware platform 800 or upon a command from operating system 806 or a user or security administrator, a processor 802 may retrieve a copy of the operational agent (or software portions thereof) from storage 850 and load it into memory 804. Processor 802 may then iteratively execute the instructions of operational agents 808 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments.

Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 800 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fibre Channel, InfiniBand, Wi-Fi, or other suitable standard. Intel Omni-Path Architecture (OPA), TrueScale, Ultra Path Interconnect (UPI) (formerly called QPI or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 800 may be virtualized, in particular the processor(s) and memory. For example, a virtualized environment may run on OS 806, or OS 806 could be replaced with a hypervisor or virtual machine manager. In this configuration, a virtual machine running on hardware platform 800 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 8 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIG. 9. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), field-programmable gate arrays (FPGAs), and other semiconductor chips.

FIG. 9 is a block illustrating selected elements of an example SoC 900. At least some of the teachings of the present specification may be embodied on an SoC 900, or may be paired with an SoC 900. SoC 900 may include, or may be paired with, an advanced reduced instruction set computer machine (ARM) component. For example, SoC 900 may include or be paired with any ARM core, such as A-9, A-15, or similar. This architecture represents a hardware platform that may be useful in devices such as tablets and smartphones, by way of illustrative example, including Android phones or tablets, iPhone (of any version), iPad, Google Nexus, Microsoft Surface. SoC 900 could also be integrated into, for example, a personal computer, server, video processing components, laptop computer, notebook computer, netbook, or touch-enabled device.

As with hardware platform 800 above, SoC 900 may include multiple cores 902-1 and 902-2. In this illustrative example, SoC 900 also includes an L2 cache control 904, a graphics processing unit (GPU) 906, a video codec 908, a liquid crystal display (LCD) I/F 910 and an interconnect 912. L2 cache control 904 can include a bus interface unit 914, a L2 cache 916. Liquid crystal display (LCD) I/F 910 may be associated with mobile industry processor interface (MIPI)/high-definition multimedia interface (HDMI) links that couple to an LCD.

SoC 900 may also include a subscriber identity module (SIM) I/F 918, a boot read-only memory (ROM) 920, a synchronous dynamic random-access memory (SDRAM) controller 922, a flash controller 924, a serial peripheral interface (SPI) director 928, a suitable power control 930, a dynamic RAM (DRAM) 932, and flash 934. In addition, one or more embodiments include one or more communication capabilities, interfaces, and features such as instances of Bluetooth, a 3G modem, a global positioning system (GPS), and an 802.11 Wi-Fi.

Designers of integrated circuits such as SoC 900 (or other integrated circuits) may use intellectual property (IP) blocks to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a nonvolatile memory (NVM) controller, Wi-Fi, Bluetooth, GPS, a fourth or fifth-generation network (4G or 5G), an audio processor, a video processor, an image processor, a graphics engine, a graphics processing unit (GPU) engine, a security controller, and many other IP blocks. In many cases, each of these IP blocks has its own embedded microcontroller.

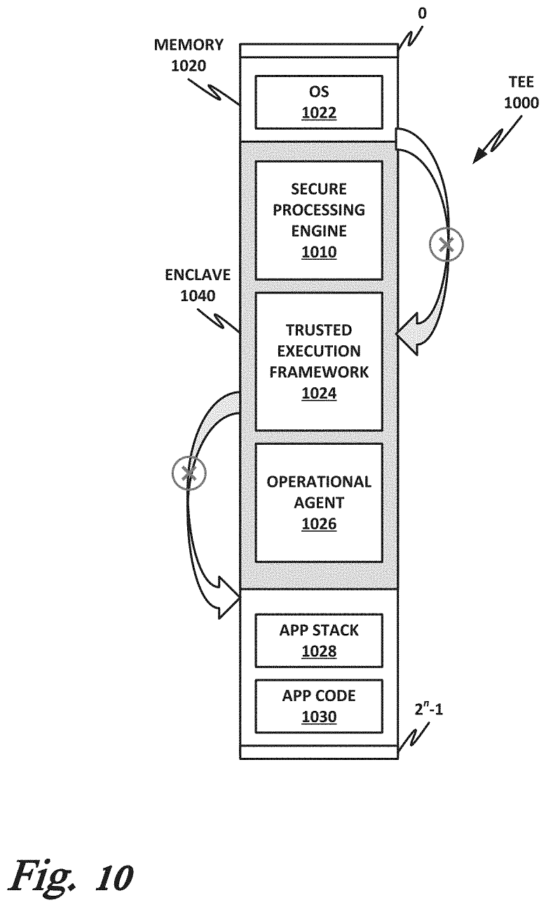

FIG. 10 is a block diagram of a trusted execution environment (TEE) 1000. TEE 1000 may be configured to provide a secure operating environment for an operational agent 1026. Within this environment, operational agent 1026 (e.g., a web conference software or plugin) can verify the security and authenticity of certain communications. For example, if a reputation, file, or other object is provided, operational agent 1026 can use a process such as direct anonymous attestation (DAA) or similar to verify the reputation, file, or object.

In the example of FIG. 10, memory 1020 is addressable by n-bits, ranging in address from 0 to 2ⁿ−1 (note, however, that in many cases, the size of the address space may far exceed the actual memory available). Within memory 1020 is an OS 1022, enclave 1040, application stack 1020, and application code 1030.

In this example, enclave 1040 is a specially-designated portion of memory 1020 that cannot be entered into or exited from except via special instructions, such as Intel Software Guard Extensions (SGX) or similar. Enclave 1040 is provided as an example of a secure environment which, in conjunction with a secure processing engine 1010, forms a trusted execution environment (TEE) 1000 on a hardware platform such as platform 800 of FIG. 8. A TEE 1000 is a combination of hardware, software, and/or memory allocation that provides the ability to securely execute instructions without interference from outside processes, in a verifiable way. By way of example, TEE 1000 may include memory enclave 1040 or some other protected memory area, and a secure processing engine 1010, which includes hardware, software, and instructions for accessing and operating on enclave 1040. Nonlimiting examples of solutions that either are or that can provide a TEE include Intel SGX, ARM TrustZone, AMD Platform Security Processor, Kinibi, securiTEE, OP-TEE, TLK, T6, Open TEE, SierraTEE, CSE, VT-x, MemCore, Canary Island, Docker, and Smack. Thus, it should be noted that in an example, secure processing engine 1010 may be a user-mode application that operates via trusted execution framework 1024 within enclave 1040. TEE 1000 may also conceptually include processor instructions that secure processing engine 1010 and trusted execution framework 1024 require to operate within enclave 1040.

Secure processing engine 1010 and trusted execution framework 1024 may together form a trusted computing base (TCB), which is a set of programs or computational units that are trusted to be secure. Conceptually, it may be advantageous to keep TCB relatively small so that there are fewer attack vectors for malware objects or for negligent software. Thus, for example, operating system 1022 may be excluded from TCB, in addition to the regular application stack 1028 and application code 1030.

In certain systems, computing devices equipped with Intel SGX or equivalent instructions may be capable of providing an enclave 1040. It should be noted, however, that many other examples of TEEs are available, and TEE 1000 is provided only as one example thereof. Other secure environments may include, by way of nonlimiting example, a virtual machine, sandbox, testbed, test machine, or other similar device or method for providing a TEE 1000.

In an example, enclave 1040 provides a protected memory area that cannot be accessed or manipulated by ordinary computer instructions. Enclave 1040 is described with particular reference to an Intel SGX enclave by way of example, but it is intended that enclave 1040 encompass any secure processing area with suitable properties, regardless of whether it is called an “enclave.”

One feature of an enclave is that once an enclave region 1040 of memory 1020 is defined, as illustrated, a program pointer cannot enter or exit enclave 1040 without the use of special enclave instructions or directives, such as those provided by Intel SGX architecture. For example, SGX™ processors provide the ENCLU[EENTER], ENCLU[ERESUME], and ENCLU[EEXIT]. These are the only instructions that may legitimately enter into or exit from enclave 1040.

Thus, once enclave 1040 is defined in memory 804, a program executing within enclave 1040 may be safely verified to not operate outside of its bounds. This security feature means that secure processing engine 1010 is verifiably local to enclave 1040. Thus, when an untrusted packet provides its content to be rendered with trusted execution framework 1024 of enclave 1040, the result of the rendering is verified as secure.

Enclave 1040 may also digitally sign its output, which provides a verifiable means of ensuring that content has not been tampered with or modified since being rendered by secure processing engine 1010. A digital signature provided by enclave 1040 is unique to enclave 1040 and is unique to the hardware of the device hosting enclave 1040.

FIG. 11 is a block diagram of a network function virtualization (NFV) infrastructure 1100. NFV is an aspect of network virtualization that is generally considered distinct from, but that can still interoperate with, SDN. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancing VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1100. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 11, an NFV orchestrator 1101 manages a number of the VNFs 1112 running on an NFVI 1100. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1101 a valuable system resource. Note that NFV orchestrator 1101 may provide a browser-based or graphical configuration interface, and in some embodiments may be integrated with SDN orchestration functions.

Note that NFV orchestrator 1101 itself may be virtualized (rather than a special-purpose hardware appliance). NFV orchestrator 1101 may be integrated within an existing SDN system, wherein an operations support system (OSS) manages the SDN. This may interact with cloud resource management systems (e.g., OpenStack) to provide NFV orchestration. An NFVI 1100 may include the hardware, software, and other infrastructure to enable VNFs to run. This may include a hardware platform 1102 on which one or more VMs 1104 may run. For example, hardware platform 1102-1 in this example runs VMs 1104-1 and 1104-2. Hardware platform 1102-2 runs VMs 1104-3 and 1104-4. Each hardware platform may include a hypervisor 1120, virtual machine manager (VMM), or similar function, which may include and run on a native (bare metal) operating system, which may be minimal so as to consume very few resources.

Hardware platforms 1102 may be or comprise a rack or several racks of blade or slot servers (including, e.g., processors, memory, and storage), one or more data centers, other hardware resources distributed across one or more geographic locations, hardware switches, or network interfaces. An NFVI 1100 may also include the software architecture that enables hypervisors to run and be managed by NFV orchestrator 1101.

Running on NFVI 1100 are a number of VMs 1104, each of which in this example is a VNF providing a virtual service appliance. Each VM 1104 in this example includes an instance of the Data Plane Development Kit (DPDK), a virtual operating system 1108, and an application providing the VNF 1112.

Virtualized network functions could include, as nonlimiting and illustrative examples, firewalls, intrusion detection systems, load balancers, routers, session border controllers, deep packet inspection (DPI) services, network address translation (NAT) modules, or call security association.

The illustration of FIG. 11 shows that a number of VNFs 1104 have been provisioned and exist within NFVI 1100. This FIGURE does not necessarily illustrate any relationship between the VNFs and the larger network, or the packet flows that NFVI 1100 may employ.

The illustrated DPDK instances 1116 provide a set of highly-optimized libraries for communicating across a virtual switch (vSwitch) 1122. Like VMs 1104, vSwitch 1122 is provisioned and allocated by a hypervisor 1120. The hypervisor uses a network interface to connect the hardware platform to the data center fabric (e.g., an HFI). This HFI may be shared by all VMs 1104 running on a hardware platform 1102. Thus, a vSwitch may be allocated to switch traffic between VMs 1104. The vSwitch may be a pure software vSwitch (e.g., a shared memory vSwitch), which may be optimized so that data are not moved between memory locations, but rather, the data may stay in one place, and pointers may be passed between VMs 1104 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1122 is illustrated, wherein vSwitch 1122 is shared between two or more physical hardware platforms 1102.

FIG. 12 is a block diagram of selected elements of a containerization infrastructure 1200. Like virtualization, containerization is a popular form of providing a guest infrastructure.

Containerization infrastructure 1200 runs on a hardware platform such as containerized server 1204. Containerized server 1204 may provide a number of processors, memory, one or more network interfaces, accelerators, and/or other hardware resources.

Running on containerized server 1204 is a shared kernel 1208. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1208 is main operating system 1212. Commonly, main operating system 1212 is a Unix or Linux-based operating system, although containerization infrastructure is also available for other types of systems, including Microsoft Windows systems and Macintosh systems. Running on top of main operating system 1212 is a containerization layer 1216. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer versus one without a daemon, like Podman. Such debates are outside the scope of the present specification, and when the present specification speaks of containerization, it is intended to include containerization layers, whether or not they require the use of a daemon.

Main operating system 1212 may also include a number of services 1218, which provide services and interprocess communication to userspace applications 1220.

Services 1218 and userspace applications 1220 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1212, they inherit the same file and resource access permissions as those provided by shared kernel 1208. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun-up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1204, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1204).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1204 hosts two containers, namely container 1230 and container 1240.

Container 1230 may include a minimal operating system 1232 that runs on top of shared kernel 1208. Note that a minimal operating system is provided as an illustrative example, and is not mandatory. In fact, container 1230 may perform as full an operating system as is necessary or desirable. Minimal operating system 1232 is used here as an example simply to illustrate that in common practice, the minimal operating system necessary to support the function of the container (which in common practice, is a single or monolithic function) is provided.

On top of minimal operating system 1232, container 1230 may provide one or more services 1234. Finally, on top of services 1234, container 1230 may also provide a number of userspace applications 1236, as necessary.

Container 1240 may include a minimal operating system 1242 that runs on top of shared kernel 1208. Note that a minimal operating system is provided as an illustrative example, and is not mandatory. In fact, container 1240 may perform as full an operating system as is necessary or desirable. Minimal operating system 1242 is used here as an example simply to illustrate that in common practice, the minimal operating system necessary to support the function of the container (which in common practice, is a single or monolithic function) is provided.

On top of minimal operating system 1242, container 1240 may provide one or more services 1244. Finally, on top of services 1244, container 1240 may also provide a number of userspace applications 1246, as necessary.

Using containerization layer 1216, containerized server 1204 may run a number of discrete containers, each one providing the minimal operating system and/or services necessary to provide a particular function. For example, containerized server 1204 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a non-volatile memory. Thus, for example, an “engine” as described above could include instructions encoded within a memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, non-transitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, non-transitory computer-readable storage media having stored thereon executable instructions that, when executed, cause a hardware platform or other computing system, to carry out a method or procedure. For example, the instructions could be executable object code, including software instructions executable by a processor. The one or more tangible, non-transitory computer-readable storage media could include, by way of illustrative and non-limiting example, a magnetic media (e.g., hard drive), a flash memory, a read-only memory (ROM), optical media (e.g., CD, DVD, Blu-Ray), non-volatile random access memory (NVRAM), non-volatile memory (NVM) (e.g., Intel 3D Xpoint), or other non-transitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a non-limiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

In order to aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1. A computing apparatus, comprising:
a hardware platform comprising a processor and a memory; and
instructions encoded within the memory to instruct the processor to:
provide access to a web conference;
determine that an object
has been shared via the web conference;
determine a reputation for the object; and
according to the reputation, modify a conference experience for at least one participant of the web conference.

2. The computing apparatus of claim 1, wherein modifying the conference experience comprises notifying the at least one participant of the reputation.

3. The computing apparatus of claim 1, wherein modifying the conference experience comprises notifying all participants of the web conference.

4. The computing apparatus of claim 1, wherein modifying the conference experience comprises blocking access to the object.

5. The computing apparatus of claim 1, wherein modifying the conference experience comprises modifying the object.

6. The computing apparatus of claim 1, wherein the object is a uniform resource locator (URL).

7. The computing apparatus of claim 1, wherein the object is a file.

8. The computing apparatus of claim 1, wherein determining the reputation of the object comprises a cloud query.

9. The computing apparatus of claim 8, wherein determining the reputation comprises determining that the file has a file type that supports executable data.

10. The computing apparatus of claim 9, wherein modifying the conference experience comprises converting the file to a static file type.

11. The computing apparatus of claim 1, wherein determining that the object has been shared comprises determining that the object was shared via a chat or instant message feature of the web conference.

12. The computing apparatus of claim 1, wherein determining that the object has been shared comprises determining that the object was shared via a screen share feature of the web conference.

13. The computing apparatus of claim 12, wherein the instructions are further to provide optical character recognition (OCR) on the screen share feature.

14. The computing apparatus of claim 1, wherein the instructions are further to determine that a remote device participating in the web conference has begun screen recording, and wherein modifying the conference experience comprises notifying the at least one participant of the screen recording.

15-25. (canceled)

26. One or more tangible, non-transitory computer-readable storage media having stored thereon executable instructions to:
initiate a web conference;
determine that a participant in the web conference has shared an object via the web conference;
query a cloud service for a reputation for the object;
receive the reputation; and
according to the reputation, modify a conference experience for at least one participant in the web conference.

27-40. (canceled)

41. The one or more tangible, non-transitory computer-readable media of claim 26, wherein the instructions are further to determine that screen recording has begun, and wherein modifying the conference experience comprises notifying the at least one participant.

42. The one or more tangible, non-transitory computer-readable media of claim 41, wherein determining that screen recording has begun comprises observing DirectX activity.

43. The one or more tangible, non-transitory computer-readable media of claim 41, wherein determining that screen recording has begun comprises statically observing an application with screen recording capability.

44-47. (canceled)

48. The one or more tangible, non-transitory computer-readable media of claim 26, wherein the instructions provide a browser plugin.

49-50. (canceled)

51. A computer-implemented method, comprising:
beginning a web conference;
determining that an object has been shared via the web conference;
receiving a reputation for the object; and
according to the reputation, modifying a conference experience for at least one participant in the web conference.

52-80. (canceled)
